(19) United States
(12) Patent Application Publication
(10) Pub. No.: US 2014/0220834 A1
(43) Pub. Date: Aug. 7, 2014

(54) SOLAR PANEL GROUNDING SYSTEM AND CLIP

(71) Applicant: DynoRaxx, Inc., Buffalo, NY (US)

(72) Inventor: Nathan T. Rizzo, Buffalo, NY (US)

(73) Assignee: DynoRaxx, Inc., Buffalo, NY (US)

(21) Appl. No.: 13/937,138

(22) Filed: Jul. 8, 2013

Related U.S. Application Data
(60) Provisional application No. 61/760,624, filed on Feb. 4, 2013.

(51) Int. Cl. H01R 4/48

(52) U.S. Cl. CPC H01R 4/4809
USPC 439/834

(57) ABSTRACT

The present invention is a clip and related grounding device. The grounding device has a wire connected to two clips at either end. Each clip is configured to be attached to the frame of a solar panel. The device eliminates fasteners that require bolts or screw to make a sufficient electrical connection between the panel frames. Because the grounding connects frame to frame, it is not necessary to ensure that the frames have a grounding connection to the underlying solar panel mounting system. This enables use of mounting systems that do not conduct electricity. The grounding device is has sufficient gripping strength that the anchoring teeth penetrate through paint, oxidized coating, or annealed finish to create an electrical connection.

### CROSS-REFERENCE TO RELATED APPLICATIONS

This application is a non-provisional that claims benefit of U.S. Patent Application Ser. No. 61/760,624 that is filed on Feb. 4, 2013.

### BACKGROUND OF THE INVENTION

1. Field of the Invention

The present invention relates generally to a grounding system and clips for solar panels.

2. Description of Background Art

Solar panels have metal frames that require grounding for safety to prevent someone from touching the frame in a short-circuited system and getting a shock or electrocuted. Because a system for producing solar electric power has large numbers of panels affixed to a complex system of metal rails, the system can be grounded by ensuring that each panel has a sufficient electrical connection between the metal panel frames and the metal rail supports. If the rail system is likewise electrically connected, a single ground wire between the rail and a ground location can complete the grounding.

Some of the most significant innovations in the solar industry are directed to lowering the overall price per kilowatt that a solar installation costs. As costs at any point in the supply chain for solar electric systems can be reduced, the overall viability of the solar system improves making it an economically favorable alternative to traditional energy sources such as coal or natural gas powered electrical plants. The time required to install a grounding system is a significant portion of the overall labor cost. Thus, some attention has been directed towards providing time saving, economical and effective grounding systems for various solar installations.

U.S. Pat. No. 8,092,129 discloses a bonding washer for making electrical connections between two metal pieces that are to be mechanically fastened together. The washer is placed between the two metal pieces and the metal pieces are tightened together by a bolt or screw. Teeth on the washer are sandwiched between the two metal pieces and gouge through the two layers being affixed. The bonding washer creates an electrical connection between a panel and the underlying support structure such as rails. The bonding washer requires a fastener such as a bolt or screw fastener, which takes considerable more time. Thus there is a need for a system that may be faster than a grounding system that requires a screw or a bolt.

U.S. Pat. No. 8,303,357 to Kuwahara discloses a grounding connection mechanism. The system has a U-shaped cam block that cooperates with a shaft to create downward pressure on a conductor/connecting washer to create a connection. Likewise, this system requires a screw or bolt.

U.S. Pat. No. 8,475,185 to discloses a grounding clip having teeth for electrically bonding two panels and to a second channel section of a top member that functions to support the panels at a predetermined angle. The system requires at least a portion of the second channel section of a top member to be metal to complete the connection. The system requires a screw or bolt to make the connection. However, if a screw or bolt fastener is required to attach the panels to the underlying rail or support, then the grounding system does not need an additional bolt. Nonetheless, if this grounding system would not be useful with a rapid fastening system that does not require a screw or bolt to fasten the panel to underlying rails.

U.S. Patent Publication No. 20110151703 discloses a swiveled electrical connector for connecting a wire to the frame of a solar panel. The system functions to connect at least one panel to a ground wire in a manner that allows the portion of the connector that clamps the wire to swivel relative to the portion of the connector that connects the panel. The device can be used to electrically connect two panels together with a common ground wire.

U.S. Pat. No. 5,451,167 discloses a grounding clip. In one embodiment, the grounding clip connects to an appliance panel and has a pair of vertical passageways into which a wire can be inserted to create a positive electrical connection for the purpose of grounding the wire to the appliance panel. It is questionable whether this grounding could be used in an all weather application. It is also questionable whether this grounding clip would be sufficiently robust for a long-term period of use consistent with solar panels.

U.S. Pat. No. 4,993,959 discloses a grounding clip comprising a U-shaped panel contact comprising inwardly directed tines. There is a wire contact section that has a crimp section. The crimp section is formed towards the side of the U-shaped panel contact. The crimping section is designed for an eighteen (18) gauge wire. The point where the crimping section connects to the remainder of the grounding device is weak and prone to breakage.

Nonetheless, there still exists a need for a grounding system that can extend a ground wire from one solar panel to another that can be applied rapidly without screws or bolts to slow the attachment process and imparts sufficient clamping strength to create a contact through a paint layer and annealing. There is a need for devices that are strong and durable capable of use in all weather conditions. One or more embodiments of the present invention addresses these and other needs.

### SUMMARY OF THE INVENTION

The present invention is a clip and related grounding device. The grounding device has a wire connected to two clips at either end. Each clip is configured to be attached to the frame of a solar panel. The device eliminates fasteners that require bolts or screw to make a sufficient electrical connection between the panel frames. Because the grounding connects frame to frame, it is not necessary to ensure that the frames have a grounding connection to the underlying solar panel mounting system. This enables use of mounting systems that do not conduct electricity to support metal frame panels that require a grounding system. The grounding device has sufficient gripping strength so that the anchoring teeth penetrate through paint, oxidized coating, or annealed finish to create an electrical connection.

A solar panel grounding clip for securing a grounding wire to a solar panel frame. The grounding clip comprises a strip of spring steel of a predetermined width that is formed and cut to define a generally U-shaped receptacle having a top clamping jaw and a bottom clamping jaw configured to receive a panel.

The receptacle has a back wall and a forward positioned mouth. The receptacle height adjacent the back wall conforms to the thickness of the solar panel frame and narrows towards the forward positioned mouth. Each of the top clamping jaw and bottom clamping jaw have one or more rearwardly and inwardly directed teeth, respectively. The mouth further defines two outwardly diverging lips defining a panel receiving opening forward the mouth. One lip is formed into a wire-crimping loop that is configured to receive and clip a grounding wire at one end of the grounding wire.

In one embodiment, the grounding clip is made of stainless spring steel. The stainless spring steel has a minimum thickness of 0.5 mm and a maximum of 0.7 mm.

In another embodiment, the receptacle has a width that is a minimum of 1.0 mm and a maximum of 3.5 mm wire creates a sufficient bond.

In one aspect of the invention, there is a solar panel grounding device for securing a grounding wire between a first solar panel frame and a second solar panel frame. The solar panel grounding device has a wire with a first end and a second end.

A first clip formed from a first strip of spring steel of a predetermined width that is formed and cut to define a generally U-shaped first receptacle configured to receive a first panel. The first clip has a first top clamping jaw and a first bottom clamping jaw. The first receptacle has a first back wall and a forward positioned first mouth. The receptacle height adjacent the back wall conforms to the thickness of the solar panel frame and narrows towards the first mouth. Each of the first top clamping jaw and first bottom clamping jaw have one or more rearwardly and inwardly directed teeth adjacent the first mouth, respectively. The first mouth further defines two outwardly diverging first lips defining a panel receiving first opening forward the first mouth. One first lip is formed into a wire 12-crimping loop and crimp holds the first end of the wire.

The solar panel grounding device has a second clip formed from a second strip of spring steel of a predetermined width that is formed and cut to define a generally U-shaped first receptacle configured to receive a second panel. The second clip has a second top clamping jaw and a second bottom clamping jaw. The second receptacle has a second back wall and a forward positioned second mouth. The receptacle height adjacent the back wall conforms to the thickness of the solar panel frame and narrows towards the second mouth. Each of the second top clamping jaw and second bottom clamping jaw have one or more rearwardly and inwardly directed teeth adjacent the second mouth, respectively. The second mouth further defines two outwardly diverging second lips defining a panel receiving second opening forward the second mouth. One second lip is formed into a wire crimping loop that is configured to receive and fasten by compressing or crimping the wire crimping loop around the grounding wire at one end of the grounding wire.

In one embodiment, the first clamp and second clamp are made of stainless spring steel. Preferably, the stainless spring steel has a minimum thickness of 0.5 mm and a maximum of 0.7 mm.

The grounding wire is a tin or nickel-plated copper wire. Preferably the wire is tin plated copper wire. Typically, the grounding wire is bare in that it does not have an insulated sheath over the wire.

In one embodiment, the wire is fourteen gauge or larger, preferably twelve gauge or larger.

The wire has a thickness that is a minimum of 0.015 inches.

In one embodiment, the receptacle has a width that is a minimum of 1.0 mm and a maximum of 3.5 mm wire creates a sufficient bond.

In another embodiment, there is a method of electrically connecting two solar panel frames comprising the steps of providing one or more of the grounding devices disclosed above. The method comprises the steps of attaching the first clip to the first frame and attaching the second clip to the second frame.

The frame and second frame are selected to have a thickness that is a minimum of 1.0 mm and a maximum of 3.5 mm.

The step of attaching the first clip and the step of attaching the second clip causes the teeth to remove a layer of annealing and/or paint.

In one embodiment of the method of the present invention, the first frame and the second frame are mounted to a mounting system or support device that is not an electrical conductor.

The present invention, including its one or more embodiments, can be better understood with reference to the following drawings, detailed description and examples, which are included to teach the invention without limiting the scope of the invention.

### BRIEF DESCRIPTION OF THE DRAWINGS

FIG. 1 is a perspective view of a grounding clip of one embodiment of the invention.

FIG. 2 is a bottom view of FIG. 1.

FIG. 3 is an elevated side view taken along the lines 3-3 of FIG. 2.

FIG. 4 is a top view taken along lines 4-4 of FIG. 3.

FIG. 5 is a plan view of the grounding clip of one embodiment showing the cuts and folds prior to stamping.

FIG. 6 is a perspective view of the grounding device of one embodiment of the present invention.

FIG. 7 is an elevated side view of the grounding device of one embodiment of the present invention.

FIG. 8 is an elevated side view of the grounding device in an expanded state receiving the solar panel frame into the grounding clip 10 receptacle 16.

### DETAILED DESCRIPTION

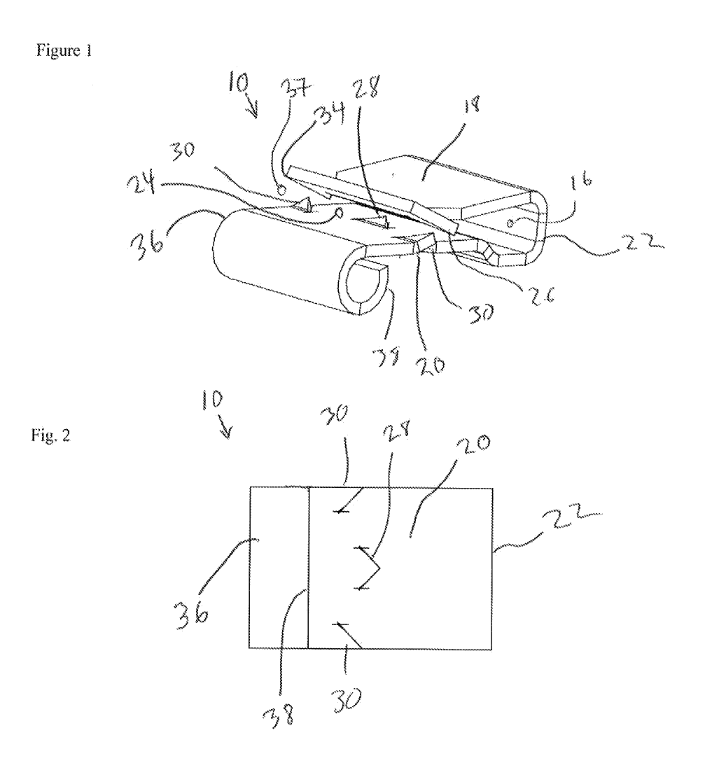

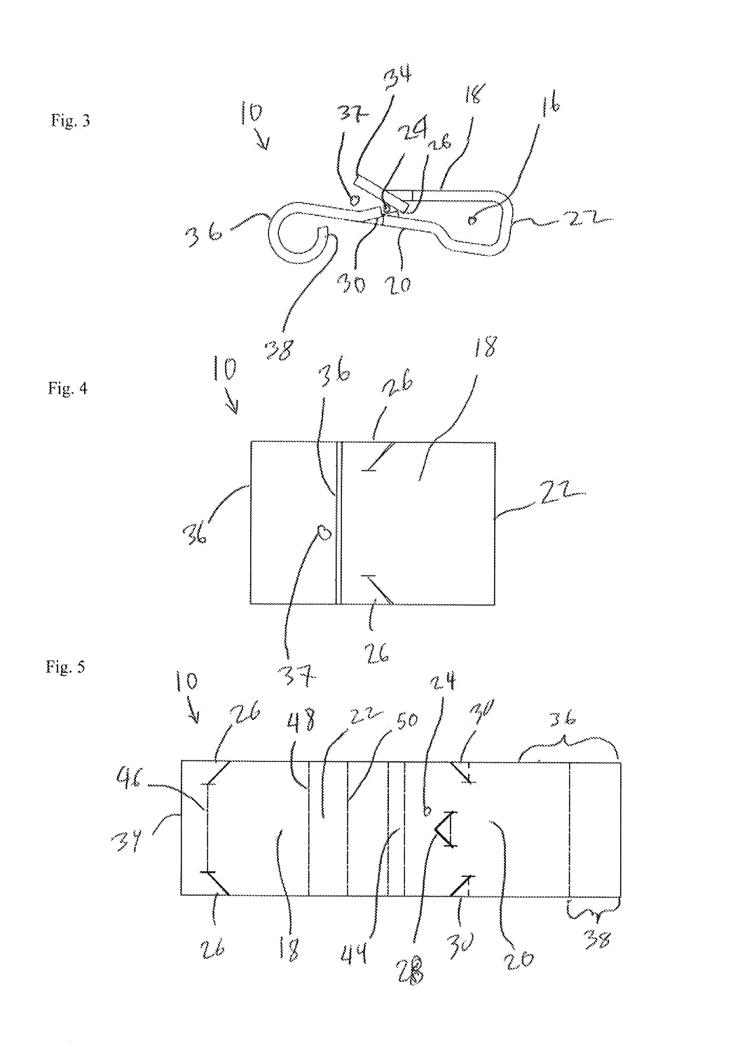

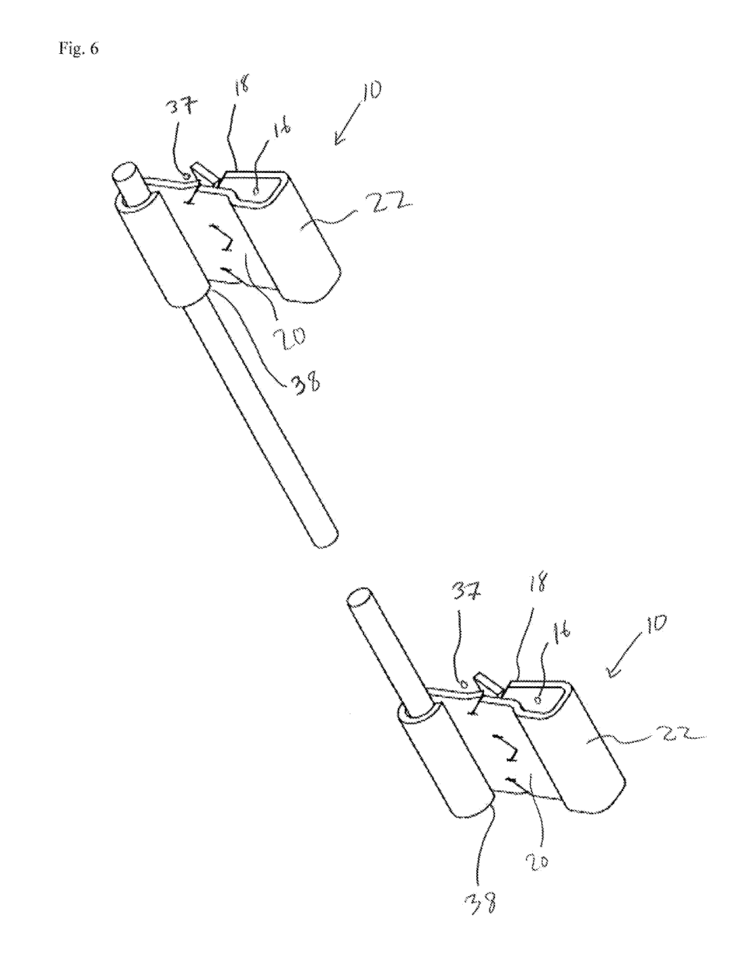

With reference to FIGS. 1-4, a grounding clip of one embodiment of the present invention is shown. The solar panel grounding clip 10 is for securing a grounding wire 12 (see FIG. 6) to a solar panel frame 8 (see FIG. 9). The grounding clip 10 is designed to provide a powerful hold on a solar panel frame 8, yet not require screws, bolts, clamps, crimping tools, pliers, lever or the like to increase the clamping force of the grounding clip 10. The simple design eliminates excessive parts and complex assembly steps making the device easy to make.

At best, a light tap of a hammer or mallet is the only assistance that a user may require to assist affixing the grounding clip 10 to the panel frame 8. Thus, the grounding clip 10 design eliminates the need for tools with the exception of a possible mallet. The grounding clip 10 comprises a strip of spring steel of a predetermined width that is formed and cut to define a generally U-shaped receptacle 16 having a top clamping jaw 18 and a bottom clamping jaw 20 configured to receive a panel frame 8 into the receptacle 16 between the jaws 18 and 20.

With particular reference to FIGS. 1 to 4, the receptacle 16 has a back wall 22 and a forward positioned mouth 24. A top lip 34 and a bottom lip 36 diverge in a forward direction from the mouth 24 to provide an opening 37 to receive the panel frame 8. The receptacle 16 height A adjacent the back wall conforms to the thickness of the solar panel frame 8 and narrows B towards the forward positioned mouth 24. The top clamping jaw 18 has two side-cut teeth 26. The bottom clamping jaw 20 has one center cut tooth 28 and two side-cut teeth 30. The teeth 26, 28, and 30 point inwardly and rearwardly.

A panel frame 8 is inserted into the receptacle 16 past the mouth 24 by a force in the direction of F₁ as shown in FIG. 8. The panel frame 8 slides into the sloped side of the teeth 26 on the top jaw 18 and the teeth 28 and 30 on the bottom jaw 20 with relative ease. Once the panel frame 8 is inserted past the tip of the forward most positioned top teeth 30, the panel frame 8 can only move into the receptacle 16. The force of the spring jaws 18 and 20 cooperate to cause the tips of the teeth 26, 28 and 30 to penetrate a layer of oxidized aluminum, annealing or even a painted layer on the panel frame 8 and grip the panel frame 8. The teeth 26, 28 and 30 are forced past the superficial oxidized or protected layer into the soft aluminum of most frames making at least five points of electrical contact.

But, when a force is applied in the direction of F₂ opposite F₁, the points of the top teeth 26, on the top jaw 18 and the points of the bottom teeth 28 and 30 on the bottom jaw 20 cooperate to dig the panel frame 8 and prevent movement of the panel frame 8 out of the mouth 24, thereby securing the panel frame 8 in the jaws 18 and 20.

As noted, the mouth 24 further defines an outwardly diverging top lip 34 and an outwardly diverging bottom lip 36. In the present embodiment of FIGS. 1-4, the bottom lip 36 is bent back into a wire-crimping loop 38 that is configured to receive and bind to a grounding wire 12 at one end of the grounding wire 12.

With reference to FIG. 5, the grounding clip 10 is made by cutting, pressing and forming an elongated strip of spring steel according to the pattern 41 of FIG. 5.

In one embodiment, the grounding clip 10 is made of stainless spring steel. The stainless spring steel has a minimum thickness of 0.5 mm and a maximum of 0.7 mm.

Top lip 34 is bent along top lip fold line 46. The top jaw 18 generally extends from top lip fold line 46 to top back wall fold line 48. The back wall 22 generally extends from top back wall fold line 48 to bottom back wall fold line 50. The receptacle 16 adjacent the back wall 22 has a width that is a minimum of 1.0 mm and a maximum of 3.5 mm, preferably 3.1 mm. A 3.2 mm receptacle 16 is effective at clipping to a panel ranging from 1.1 mm to 3.06 mm.

The bottom jaw extends from bottom back wall fold line 50 to approximately the mouth 24 that begins proximate bottom teeth 26 and 28. A jogging double bend formed in region 44 will be formed to narrow the receptacle 16 from the portion of the receptacle 16 adjacent the back wall 22 towards the mouth 24. Bottom teeth 26 and 28 when processed are cut to the shape of the teeth 26 and 28. They are pressed upward from the bottom jaw 20 on an angle in a rearward direction. The bottom lip 36 is rolled to form the wire-crimping loop 38.

The system can be stamped in multiple steps or formed with a four-way press such as a four-slide press. The grounding wire 12 is connected to the grounding clips by compressing the wire crimping loop onto the wire in the four slide press at the factory while the grounding clips 10 are being pressed to ensure connection of consistent quality and save time at the installation site. Grounding wires 12 can be of a predetermined length.

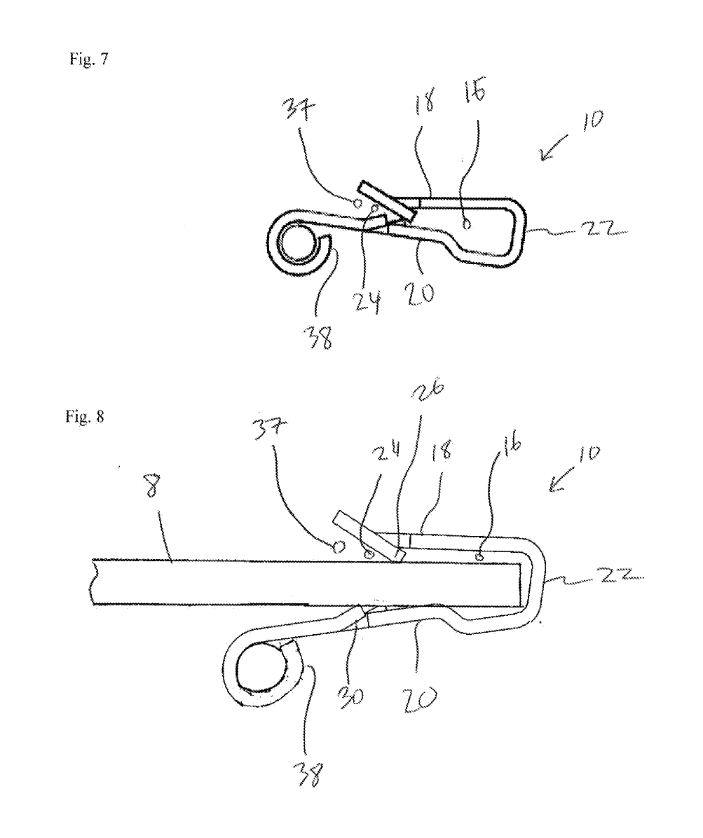

In one embodiment shown in FIGS. 6-8, two clips 10 of one or more embodiments described above are attached to each ends of a grounding wire 12 of predetermined length and thickness.

The grounding wire 12 is a tin or nickel-plated copper wire. Preferably the grounding wire 12 is tin plated copper wire. Typically, the grounding wire 12 is bare in that it does not have an insulated sheath over the grounding wire 12.

In one embodiment, the grounding wire 12 is fourteen gauge or larger, preferably twelve gauge or larger. Depending upon the application, a 12 gauge wire having a 2.1 mm diameter is sufficient to ground most 12 panel arrays.

In another embodiment, there is a method of electrically connecting two solar panel frames comprising the steps of providing one or more of the grounding devices disclosed above. A clip 10 is affixed to the underside of a panel frame 8 by placing the mouth 24 of the grounding clip 10 directly over the panel frame 8. The user (preferably wearing work gloves) can grasp the panel frame 8 and the grounding clip 10 between the thumb and forefinger and press until the grounding clip 10 slides over the panel frame 8 until the panel frame 8 abuts against the back wall 16 of the grounding clip 10 or close to the back wall 16. The grounding wire 12, preferably unbent extends longitudinally along the frame 8 to an adjacent frame 8.

The step of attaching the first clip and the step of attaching the second clip causes the teeth to remove a layer of annealing and/or paint by creating a gouge or groove in the paint, annealed surface or oxidized layer. The removal of this covering layer is an important part of the invention because it improves the quality of the connection.

In one embodiment of the method of the present invention, the first frame and the second frame are mounted to a mounting system or support device that is not an electrical conductor.

### Example 1

### Short-Time Current Test

Method: Three samples of the grounding device were subjected to the above test.

The grounding device was not intended for attachment to a rod, conduit, pipe, outlet box etc., and so was assembled in the intended manner using its largest rated conductor. Specifically, in each of the three samples a grounding wire 12 connected two solar panel frames.

The grounding device was subjected to the test current for the specified time. The test current passed through the first panel, the first clip, the 12-gauge nickel-plated grounding, the second clip and the second solar panel frame in series. The current of 470 Amps was passed through for four seconds.

After having carried the specified current, the test sample assembly was evaluated for continuity from the first panel through the grounding device to the second panel. An indicating device such as an ohmmeter, battery-and-buzzer combination, or the like, was used to determine whether electrical continuity existed after the system was subject to the current.

Results: The results were acceptable since the grounding or bonding device did not crack, break, or melt and continuity was maintained on all sample assemblies.

What is claimed is:

1. A solar panel grounding clip for securing a grounding wire to a solar panel frame, the solar panel comprising:
a strip of spring steel of a predetermined width that is formed and cut to define a generally U-shaped receptacle having a top clamping jaw and a bottom clamping jaw configured to receive a panel;
wherein the receptacle has a back wall and a forward positioned mouth;
wherein the receptacle height adjacent the back wall conforms to the thickness of the solar panel frame and narrows towards the forward positioned mouth;
wherein the top clamping jaw and bottom clamping jaw each have one or more rearwardly and inwardly directed teeth, respectively;
wherein the mouth further defines two outwardly converging lips defining a panel receiving opening forward the mouth;
wherein one lip is formed into a wire crimping loop that is configured to receive and affix by compression or crimping a grounding wire at one end of the grounding wire.

2. The grounding device of claim 1, wherein the grounding clip is made of stainless spring steel.

3. The grounding device of claim 2, wherein the stainless spring steel has a minimum thickness of 0.5 mm and a maximum of 0.7 mm.

4. The grounding device of claim 2, wherein the receptacle has a width that is a minimum of 1.0 mm and a maximum of 3.5 mm wire creates a sufficient bond.

5. A solar panel grounding device for securing a grounding wire between a first solar panel frame and a second solar panel frame, the device comprising:
a wire having a first end and a second end;
a first clip formed from a first strip of spring steel of a predetermined width that is formed and cut to define a generally U-shaped first receptacle configured to receive a first panel, the first clip has a first top clamping jaw and a first bottom clamping jaw; wherein the first receptacle has a first back wall and a forward positioned first mouth; wherein the receptacle height adjacent the back wall conforms to the thickness of the solar panel frame and narrows towards the first mouth; wherein the first top clamping jaw and first bottom clamping jaw each have one or more rearwardly and inwardly directed teeth adjacent the first mouth, respectively; wherein the first mouth further defines two outwardly converging first lips defining a panel receiving first opening forward the first mouth; and wherein one first lip is formed into a wire crimping loop and crimp holds the first end of the wire; and
a second clip formed from a second strip of spring steel of a predetermined width that is formed and cut to define a generally U-shaped first receptacle configured to receive a second panel, the second clip has a second top clamping jaw and a second bottom clamping jaw; wherein the second receptacle has a second back wall and a forward positioned second mouth; wherein the receptacle height adjacent the back wall conforms to the thickness of the solar panel frame and narrows towards the second mouth; wherein the second top clamping jaw and second bottom clamping jaw each have one or more rearwardly and inwardly directed teeth adjacent the second mouth, respectively; wherein the second mouth further defines two outwardly converging second lips defining a panel receiving second opening forward the second mouth; and wherein one second lip is formed into a wire crimping loop that is configured to receive and clip a grounding wire at one end of the grounding wire.

6. The grounding device of claim 5, wherein the first and second clip are made of stainless spring steel.

7. The grounding device of claim 6, wherein the stainless spring steel has a minimum thickness of 0.5 mm and a maximum of 0.7 mm.

8. The grounding device of claim 7, wherein the wire is a tin or nickel-plated copper wire.

9. The grounding device of claim 8, wherein the wire is bare.

10. The grounding device of claim 9, wherein the wire is twelve gauge or larger.

11. The grounding device of claim 10, wherein the wire has a thickness that is a minimum of 0.015 inches.

12. The grounding device of claim 11, wherein the receptacle has a width that is a minimum of 1.0 mm and a maximum of 3.5 mm wire creates a sufficient bond.

13. A method of electrically connecting two solar panel frames comprising the steps of:
providing a device of claim 5;
attaching the first clip to the first frame; and
attaching the second clip to the second frame.

14. The method of claim 13, wherein the first frame and second frame is selected to have a thickness that is a minimum of 1.0 mm and a maximum of 3.5 mm.

15. The method of claim 13, wherein the step of attaching the first clip and the step of attaching the second clip causes the teeth to remove a layer of annealing and/or paint.

16. The method of claim 13, wherein the first frame and the second frame are mounted to a mounting system or support device that is not an electrical conductor.
